(19) United States
(12) Patent Application Publication
(10) Pub. No.: US 2020/0267637 A1
(43) Pub. Date: Aug. 20, 2020

(54) CELLULAR MODEM SELECTION AT A VEHICLE WHILE THE VEHICLE IS IN A PRIMARY PROPULSION OFF STATE

(71) Applicant: GM GLOBAL TECHNOLOGY OPERATIONS LLC, Detroit, MI (US)

(72) Inventors: Alex J. Veloso, Rochester Hills, MI (US); Dipanker Pal, Sylvania, OH (US); Scott T. Droste, West Bloomfield, MI (US); Woongjin Lim, Lincolnshire, IL (US); George Knish, Rochester Hills, MI (US)

(21) Appl. No.: 16/277,620

(22) Filed: Feb. 15, 2019

(51) Int. Cl. H04W 48/00; H04W 48/16; H04W 88/06; H04B 17/318; H04B 17/382; H04W 48/04; H04W 4/40; H04W 72/08

(52) U.S. Cl. CPC H04W 48/17; H04W 48/16; H04W 88/06; H04W 72/085; H04B 17/382; H04W 48/04; H04W 4/40; H04B 17/318

(57) ABSTRACT

A system and method of selecting a modem for cellular communications while the vehicle is in a primary propulsion off state. The method includes: detecting a transition from a primary propulsion on state to a primary propulsion off state of the vehicle; after detecting the transition from the primary propulsion on state to the primary propulsion off state, measuring one or more cellular connectivity parameters for a plurality of modems included in the vehicle; based on the cellular connectivity parameter(s), selecting a modem of the plurality of modems; after selecting the modem of the plurality of modems, then turning off non-selected modem(s) of the plurality of modems, wherein the non-selected modem(s) include the plurality of modems other than the selected modem; and sending a selected modem indication to a remote server, wherein the selected modem indication indicates to the remote server to use the selected modem when sending messages to the vehicle.

### INTRODUCTION

The present invention relates to cellular communications at a vehicle while the vehicle is in a primary propulsion off state.

Cellular networks (or cellular carrier systems) provide cellular communications for a variety of cellular devices, referred to broadly herein as user equipment (UE). In some instances, for certain mobile user equipment, it is desirable to constantly have cellular connectivity. Certain locations experience distinct levels of cellular service, and in some instances, cellular coverage for a particular location may vary depending on a variety of factors.

### SUMMARY

According to one aspect of the invention, there is provided a method of selecting a modem for cellular communications while the vehicle is in a primary propulsion off state. The method includes: detecting a transition from a primary propulsion on state to a primary propulsion off state of the vehicle; after detecting the transition from the primary propulsion on state to the primary propulsion off state, measuring one or more cellular connectivity parameters for a plurality of modems included in the vehicle; based on the cellular connectivity parameter(s), selecting a modem of the plurality of modems; after selecting the modem of the plurality of modems, then turning off non-selected modem(s) of the plurality of modems, wherein the non-selected modem(s) include the plurality of modems other than the selected modem; and sending a selected modem indication to a remote server, wherein the selected modem indication indicates to the remote server to use the selected modem when sending messages to the vehicle.

According to various embodiments, this method may further include any one of the following features or any technically-feasible combination of some or all of these features:
the cellular connectivity parameter(s) include(s) a cellular signal strength parameter;
the cellular signal strength parameter is a received signal strength indicator (RSSI);
the measuring step includes measuring K samples of the RSSI for each of the plurality of modems and then determining a representative RSSI value;
the cellular connectivity parameter(s) include(s) a standard deviation of the RSSI as measured based on the K samples;
an overall cellular connectivity value is determined for two or more of the plurality of modems by dividing the representative RSSI value by the standard deviation of the RSSI and, then, carrying out the selecting step based on the overall cellular connectivity values;
the selecting step includes comparing the representative RSSI values for each of the plurality of modems to a first cellular connectivity parameter threshold and, when it is determined that the representative RSSI values for an associated modem is above the first cellular connectivity parameter threshold, then determining the overall cellular connectivity value for the associated modem;
the selecting step includes comparing the standard deviation of the RSSI for each of the plurality of modems to a second cellular connectivity parameter threshold and, when it is determined that both the representative RSSI values for the associated modem is above the first cellular connectivity parameter threshold and the standard deviation of the RSSI for the associated modem is below the second cellular connectivity parameter threshold, then determining the overall cellular connectivity value for the associated modem;
the steps of: monitoring at least one cellular connectivity parameter for the selected modem while the vehicle is in the primary propulsion off state by measuring the cellular connectivity parameters for the selected modem; and based on the at least one cellular connectivity parameter, determining whether to select a new modem for cellular communications while the vehicle is in the primary propulsion off state;
the determining step includes comparing a first cellular connectivity parameter of the at least one cellular connectivity parameter to a first cellular connectivity parameter threshold; and/or
when it is determined to select a new modem for cellular communications while the vehicle is in the primary propulsion off state, then carrying out the measuring step for the non-selected modem(s) and the selecting step to select a modem of the non-selected modem(s) to be the selected modem.

According to another aspect of the invention, there is provided a method for cellular communications while the vehicle is in a primary propulsion off state. The method includes: detecting a transition from a primary propulsion on state to a primary propulsion off state of the vehicle; after detecting the transition from the primary propulsion on state to the primary propulsion off state, measuring a plurality of cellular connectivity parameters for a plurality of cellular modems included in the vehicle, wherein the cellular connectivity parameters include a cellular signal strength parameter and a standard deviation of the cellular signal strength parameter as taken over K samples of the cellular signal strength parameter; based on the cellular connectivity parameters, selecting a modem of the plurality of modems by: (i) comparing the cellular signal strength parameter to a first cellular connectivity parameter threshold, (ii) comparing the standard deviation of the cellular signal strength parameter to a second cellular connectivity parameter threshold, (iii) for each of the plurality of modems in which both the cellular signal strength parameter is above the first cellular connectivity parameter threshold and the standard deviation of the cellular signal strength parameter is below a second cellular connectivity parameter threshold, determining an overall cellular connectivity value based on the cellular signal strength parameter and the standard deviation of the cellular signal strength parameter, and (iv) selecting the modem with the best overall cellular connectivity value; after selecting the modem of the plurality of modems, then turning off non-selected modem(s) of the plurality of modems, wherein the non-selected modem(s) include the plurality of modems other than the selected modem; and sending a selected modem indication to a remote server, wherein the selected modem indication informs the remote server of a cellular provider that is associated with the selected modem and that is to be used for communications between the vehicle and the remote server.

According to various embodiments, this method may further include any one of the following features or any technically-feasible combination of some or all of these features:
a first modem of the plurality of modems is configured to provide cellular services for the vehicle using a first cellular provider, wherein a second modem of the plurality of modems is configured to provide cellular services for the vehicle using a second cellular provider, and wherein the first cellular provider is different than the second cellular provider;
the steps of: monitoring at least one cellular connectivity parameter for the selected modem while the vehicle is in the primary propulsion off state; and based on the at least one cellular connectivity parameter, determining whether to select a new modem for cellular communications while the vehicle is in the primary propulsion off state;
wherein, when it is determined to select a new modem for cellular communications while the vehicle is in the primary propulsion off state, then carrying out the measuring step for the non-selected modem(s) and the selecting step to select a modem of the non-selected modem(s) to be the selected modem;
wherein the best overall cellular connectivity value is determined to be associated with the lowest anticipated amount of electrical power consumption;
receiving a remote vehicle command at the selected modem from the remote server while the vehicle is in the primary propulsion off state;
the method is carried out by a telematics unit included in the vehicle, and wherein the telematics unit includes the plurality of modems;
the method further comprises turning on each of the plurality of modems in response to detecting a transition from the primary propulsion off state to the primary propulsion on state; and/or
the vehicle informs the remote server of vehicle operation in response to detecting the transition from the primary propulsion off state to the primary propulsion on state so that the remote server is informed of which modems of the plurality of modems are turned on.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein;

FIG. 2 is a block diagram depicting a scenario in which cellular coverage for a particular location changes with time;

FIG. 3 is a flowchart of an embodiment of a method for cellular communications while the vehicle is in a primary propulsion off state; and

FIG. 4 is a flowchart of an embodiment of a method for monitoring cellular connectivity parameters for a selected modem.

### DETAILED DESCRIPTION

The system and method described below permits a vehicle to select a modem of a plurality of modems to use for cellular communications while the vehicle is in a primary propulsion off state. Some vehicles may include more than one (or a plurality of) modems for cellular communications. In such instances, the vehicle may have a default or preferred modem that is used for cellular communications while the vehicle is in a primary propulsion off state. However, the cellular coverage for communications using this modem (which may be associated with a particular cellular provider) may not be suitable or desirable for certain geographical locations. Moreover, the vehicle may be equipped with another modem (which may be associated with a different cellular provider) that exhibits better or preferred cellular coverage. Thus, according to at least some embodiments, the method and system below enable selection of a modem based on cellular connectivity as determined when the vehicle is turned off (i.e., set to a primary propulsion off state). In some instances, the vehicle can use a discontinuous reception (DRX) mode when the vehicle is in the primary propulsion off state so as to conserver battery power. In some embodiments, the method can be used to supplement or modify a discontinuous reception mode so that, for example, a single modem can be selected for cellular communications while the vehicle is in the primary propulsion off state.

In one embodiment, the method includes: detecting a transition from a primary propulsion on state to a primary propulsion off state of the vehicle; measuring cellular connectivity parameters for a plurality of modems included in the vehicle; selecting a modem based on the cellular connectivity parameters; and turning off non-selected modem(s) of the plurality of modems, wherein the non-selected modem(s) include the plurality of modems other than the selected modem. In at least one embodiment, the method can further include sending a selected modem indication to a remote server, which informs the remote server of the selected modem so that the remote server can address communications to the selected modem. In at least some embodiments, the method improves the consistency of the vehicle's cellular connectivity and/or the success rate of cellular communications between the vehicle and a remote server, which (in at least some scenarios) can prove useful for instances where the vehicle is controlled remotely, such as through the use of a mobile device (e.g., smartphone) application.

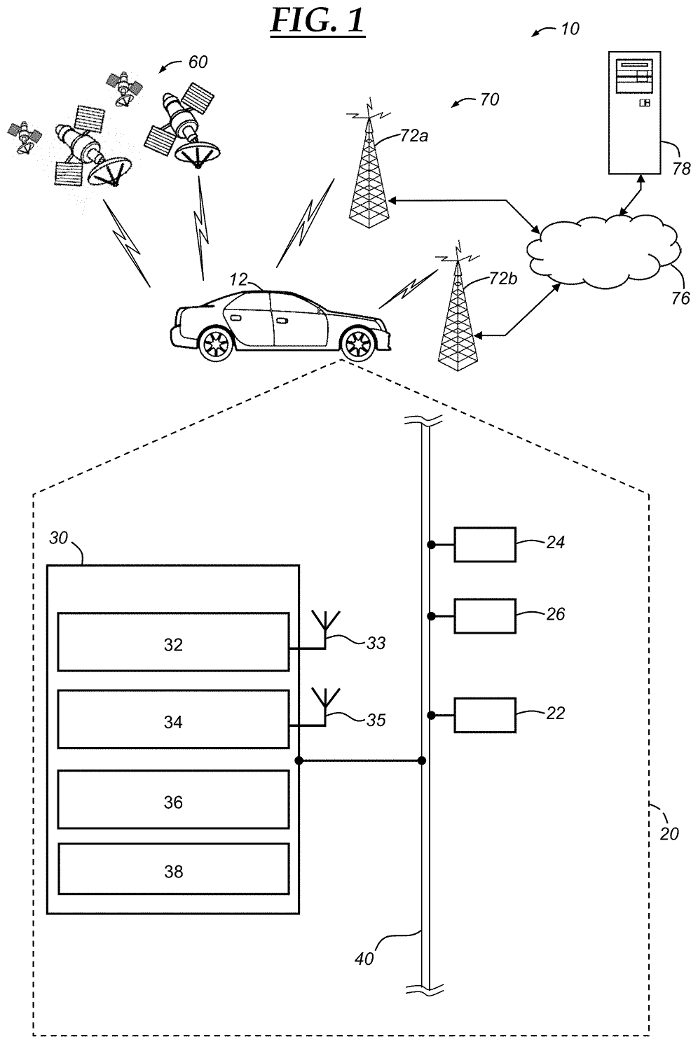

With reference to FIG. 1, there is shown an operating environment that comprises a communications system 10 and that can be used to implement the method disclosed herein. Communications system 10 generally includes a vehicle 12 with a telematics unit 30 and other VSMs 22-26, a constellation of global navigation satellite system (GNSS) satellites 60, one or more cellular systems (or networks) 70, a land communications network 76, and a remote server 78. It should be understood that the disclosed method can be used with any number of different systems and is not specifically limited to the operating environment shown here. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft including unmanned aerial vehicles (UAVs), etc., can also be used. Some of the vehicle electronics 20 are shown generally in FIG. 1 and includes a global navigation satellite system (GNSS) receiver 22, a body control module or unit (BCM) 24, an engine control module (ECM) 26, and a telematics unit 30. Some or all of the different vehicle electronics may be connected for communication with each other via one or more communication busses, such as communications bus 40. The communications bus 40 provides the vehicle electronics with network connections using one or more network protocols and can use a serial data communication architecture. Examples of suitable network connections include a controller area network (CAN), a media oriented system transfer (MOST), a local interconnection network (LIN), a local area network (LAN), and other appropriate connections such as Ethernet or others that conform with known ISO, SAE, and IEEE standards and specifications, to name but a few.

The vehicle 12 can include numerous vehicle system modules (VSMs) as part of vehicle electronics 20, such as the GNSS receiver 22, the BCM 24, the ECM 26, and the telematics unit 30, as will be described in detail below. The vehicle 12 can also include other VSMs in the form of electronic hardware components that are located throughout the vehicle and which may receive input from one or more sensors and use the sensed input to perform diagnostic, monitoring, control, reporting, and/or other functions. Each of the VSMs can be connected by communications bus 40 to the other VSMs, as well as to the telematics unit 30, and can be programmed to run vehicle system and subsystem diagnostic tests. Moreover, each of the VSMs can include and/or be communicatively coupled to suitable hardware that enables intra-vehicle communications to be carried out over the communications bus 40; such hardware can include, for example, bus interface connectors and/or modems. One or more VSMs may periodically or occasionally have their software or firmware updated and, in some embodiments, such vehicle updates may be over the air (OTA) updates that are received from a remote server 78 via land network 76 and telematics unit 30. As is appreciated by those skilled in the art, the above-mentioned VSMs are only examples of some of the modules that may be used in vehicle 12, as numerous others are also possible.

Global navigation satellite system (GNSS) receiver 22 receives radio signals from a constellation of GNSS satellites 60. GNSS receiver 22 can be configured to comply with and/or operate according to particular regulations or laws of a given geopolitical region (e.g., country). The GNSS receiver 22 can be configured for use with various GNSS implementations, including global positioning system (GPS) for the United States, BeiDou Navigation Satellite System (BDS) for China, Global Navigation Satellite System (GLONASS) for Russia, Galileo for the European Union, and various other navigation satellite systems. For example, the GNSS receiver 22 may be a GPS receiver, which may receive GPS signals from a constellation of GPS satellites 60. And, in another example, GNSS receiver 22 can be a BDS receiver that receives a plurality of GNSS (or BDS) signals from a constellation of GNSS (or BDS) satellites 60. In either implementation, GNSS receiver 22 can include at least one processor and memory, including a non-transitory computer readable memory storing instructions (software) that are accessible by the processor for carrying out the processing performed by the receiver 22. In one embodiment. the vehicle location can be determined through the GNSS receiver 22 and reported to a remote server, such as the remote server 78.

Body control module (BCM) 24 can be used to control various VSMs of the vehicle, as well as obtain information concerning the VSMs, including their present state or status, as well as sensor information. The BCM 24 is shown in the exemplary embodiment of FIG. 1 as being electrically coupled to the communication bus 40. In some embodiments, the BCM 24 may be integrated with or part of a center stack module (CSM). Or, the BCM may be a separate device that is connected to other VSMs via bus 40. The BCM 24 can include a processor and/or memory, which can be similar to processor 36 and memory 38 of telematics unit 30, as discussed below. The BCM 24 may communicate with telematics unit 30 and/or one or more vehicle system modules, such as the engine control module (ECM) 26. Software stored in the memory and executable by the processor enables the BCM to direct one or more vehicle functions or operations including, for example, controlling central locking, air conditioning, power mirrors, controlling the vehicle primary mover (e.g., engine, primary propulsion system), and/or controlling various other vehicle modules.

Engine control module (ECM) 26 may control various aspects of engine operation such as fuel ignition and ignition timing. The ECM 26 is connected to the communications bus 40 and may receive operation instructions (or vehicle commands) from the BCM 24 or other vehicle system modules, such as the telematics unit 30 or other VSMs. In one scenario, the ECM 26 may receive a command from the BCM to place the vehicle in a primary propulsion on state (from a primary propulsion off state)—i.e., initiate the vehicle ignition or other primary propulsion system (e.g., a battery powered motor). In at least some embodiments when the vehicle is a hybrid or electric vehicle, a primary propulsion control module can be used instead of (or in addition to) the ECM 26, and this primary propulsion control module can be used to obtain status information regarding the primary mover (including electrical motor(s) and battery information). A primary propulsion off state refers to a state in which the primary propulsion system of the vehicle is off, such as when the internal combustion engine is not running or idling, when a vehicle key is not turned to a START or ON (or accessory) position, or when the power control system for one or more electric motors of an electric vehicle is powered off or not enabled. A primary propulsion on state is a state that is not a primary propulsion off state.

Additionally, the BCM 24 and/or the ECM 26 may provide vehicle state information corresponding to the vehicle state or of certain vehicle components or systems, including the VSMs discussed herein. For example, the BCM 24 and/or the ECM 26 may provide the telematics unit 30 with information indicating whether the vehicle is in a primary propulsion on state or a primary propulsion off state, battery information from a vehicle battery system, etc. The information can be sent to the telematics unit 30 (or other vehicle computer/controller) automatically upon receiving a request from the device/computer, automatically upon certain conditions being met, upon a request from another VSM, or periodically (e.g., at set time intervals). The BCM 24 and/or the ECM 26 can also be used to detect the presence of a predetermined vehicle operating condition, which can be carried out by (for example) comparing the predetermined vehicle operating condition (or information pertaining thereto) to current vehicle operating conditions (or present vehicle information). The BCM 24 and/or the ECM 26 can then wake-up or otherwise inform the telematics unit 30 of this event. In other embodiments, the telematics unit 30 can carry out this detecting function based on information received from the BCM 24 and/or the ECM 26.

Telematics unit 30 is capable of carrying out cellular communications using one or more cellular networks (or carrier systems) 70. In the illustrated embodiment, telematics unit 30 includes a first cellular modem (or cellular chipset) 32, a second cellular modem (or cellular chipset) 34, a processor 36, memory 38, and antennas 33 and 35. In one embodiment, telematics unit 30 may be a standalone module or, in other embodiments, the telematics unit 30 may be incorporated or included as a part of one or more other vehicle system modules, such as a center stack module (CSM), GNSS receiver 22, BCM 24, an infotainment module, a head unit, and/or a gateway module. The telematics unit can include any number of cellular modems (or “modems” for short), which can be or include cellular chipsets. Each of the modems can include or be associated with subscription information, such as an International Mobile Station Identifier (IMSI), or other UE-related information, such as an International Mobile Equipment Identifier (IMEI).

The telematics unit 30 is an example of user equipment (UE) and, in particular, vehicle user equipment, which is a UE that is installed as a part of the vehicle electronics. The telematics unit 30 includes a plurality of modems 32, 34, each of which can be associated with a different cellular service provider (e.g., Verizon™, AT&T™). In one embodiment, the processor and/or memory of the telematics unit 30 can be shared with other VSMs or used for other functionality. For example, the telematics unit 30 can share the processor 36 and/or the memory 38 with other VSMs, such as an infotainment unit. Or, in other embodiments, a separate telematics unit can be included in the vehicle and communicatively coupled to these other VSMs, such as is shown in FIG. 1. In one embodiment, the telematics unit can be integrated with the GNSS receiver 22 so that, for example, the GNSS receiver 22 and the telematics unit 30 are directly connected to one another as opposed to being connected via communications bus 40.

The telematics unit 30 may enable the vehicle 12 to be in communication with one or more remote networks (e.g., one or more networks at remote server 78) via packet-switched data communication. This packet-switched data communication may be carried out through use of a non-vehicle wireless access point that is connected to a land network via a router or modem. When used for packet-switched data communication such as TCP/IP, the telematics unit 30 can be configured with a static IP address or can be set up to automatically receive an assigned IP address from another device on the network such as a router or from a network address server.

Packet-switched data communications may also be carried out via use of a cellular network that may be accessible by the telematics unit 30. The cellular modems 32, 34 can enable data to be communicated over the cellular system 70. In such an embodiment, radio transmissions may be used to establish a communications channel, such as a voice channel and/or a data channel, with cellular system 70 so that voice and/or data transmissions can be sent and received over the channel. Data can be sent either via a data connection, such as via packet data transmission over a data channel, or via a voice channel using techniques known in the art. For combined services that involve both voice communication and data communication, the system can utilize a single telephone call over a voice channel and switch as needed between voice and data transmission over the voice channel, and this can be done using techniques known to those skilled in the art.

Processor 36 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. The processor 36 executes various types of digitally-stored instructions, such as software or firmware programs stored in memory 38, which enable the telematics unit 30 to provide a wide variety of services. Memory 38 may be a non-transitory computer-readable medium, such as a powered temporary memory or any suitable non-transitory, computer readable medium; these include different types of RAM (random-access memory, including various types of dynamic RAM (DRAM) and static RAM (SRAM)), ROM (read-only memory), solid-state drives (SSDs) (including other solid-state storage such as solid-state hybrid drives (SSHDs)), hard disk drives (HDDs), or magnetic or optical disc drives.

Land network 76 may be a conventional land-based telecommunications network that is connected to one or more landline telephones and connects cellular system 70 to remote server 78. For example, land network 76 may include a public switched telephone network (PSTN) such as that used to provide hardwired telephony, packet-switched data communications, and the Internet infrastructure. One or more segments of land network 76 could be implemented through the use of a standard wired network, a fiber or other optical network, a cable network, power lines, other wireless networks such as wireless local area networks (WLANs), networks providing broadband wireless access (BWA), or any combination thereof.

The remote server 78 (only one shown) can be some of a number of computers accessible via a private or public network such as the Internet. Although only a single remote server is referred to herein, the “remote server” can include one or more remote servers. The remote server 78 can be used for one or more purposes, such as for providing information regarding UEs. In some embodiments, the remote server 78 can be, for example: a service center computer where diagnostic information and other vehicle data can be uploaded from the vehicle; a client computer used by the vehicle owner or other subscriber for various purposes, such as accessing and/or receiving vehicle sensor data (or other data), as well as setting up and/or configuring subscriber preferences or controlling vehicle functions; a car sharing server which coordinates registrations from a plurality of users who request to use a vehicle as part of a car sharing service; or a third party repository to or from which vehicle sensor data or other information is provided, whether by communicating with the vehicle 12, remote server 78, or both.

Wireless carrier system (or cellular system) 70 may be any suitable cellular telephone system, and can include cellular networks of multiple different cellular providers. Carrier system 70 is shown as including two cellular towers 72a, 72b; however, the carrier system 70 may include any number of the following components (e.g., depending on the cellular technology): cellular towers, base transceiver stations, mobile switching centers, base station controllers, evolved and next generation nodes (e.g., eNodeBs, gNodeBs), mobility management entities (MATEs), access and mobility management function entities (AMFs), serving and PGN gateways, etc., as well as any other networking components required to connect wireless carrier system 70 with the land network 76 or to connect the wireless carrier system with user equipment (UEs, e.g., which can include telematics equipment in vehicle 12). Carrier system 70 can implement any suitable communications technology, including GSM/GPRS technology, CDMA or CDMA2000 technology, LTE technology, 5G NR (New Radio) technology, etc. In general, wireless carrier systems 70, their components, the arrangement of their components, the interaction between the components, etc. is generally known in the art.

In one embodiment, the cellular system 70 is a cellular network that operates according to a 3rd Generation Partnership Project (3GPP) specification, such as the 3GPP 24.301 for 4G LTE circuit-switched and/or packet data services. Additionally or alternatively, the cellular system 70 can operate to provide 3G circuit-switched services and/or 3G packet data services according to the technical specification of 3GPP 24.008, and/or 5G New Radio packet data services according to the technical specification of 3GPP 24.501. Related network procedures for 3G operation, 4G LTE operation, and/or 5G operation can be found in the technical specifications of 3GPP 23.060, 23.401, and/or 23.501, as will be appreciated by those skilled in the art. Also, the cellular system 70 can include multiple cellular networks that each operate according to one or more specifications, including any suitable combination of those discussed above and/or other specifications not expressly discussed herein.

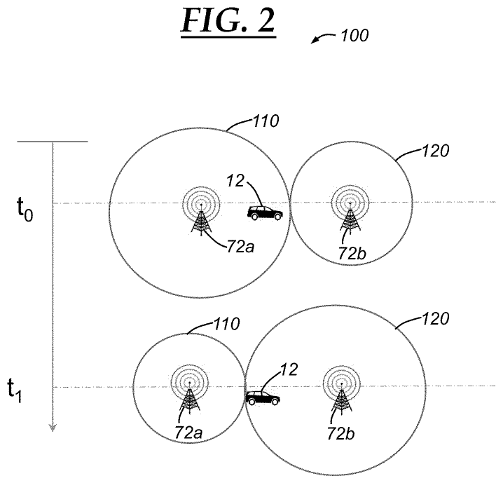

With reference to FIG. 2, there is shown a scenario in which the vehicle remains in a fixed location and in which at least one of a first area of cellular coverage and a second area of cellular coverage changes. In the illustrated scenario, the vehicle 12 is in a primary propulsion off state at times t₀ and t₁. The cellular carrier system 70 includes a first cellular coverage area 110 that is provided by (or otherwise associated with) the first cellular tower 72a and a second coverage area 120 that is provided by (or otherwise associated with) the second cellular tower 72b. The first cellular tower 72a and the first cellular coverage area 110 are associated with a first cellular provider, and the second cellular tower 72b and the second cellular coverage area 120 are associated with a second cellular provider. In many embodiments, the first cellular provider and the second cellular provider are different from one another; for example, the first cellular provider can be Verizon™ and the second cellular provider can be AT&T™. Additionally, the telematics unit 30 includes a plurality of modems, where the first modem 32 is associated with the first cellular provider and the second modem 34 is associated with the second cellular provider. As mentioned above, the telematics unit can include any number of modems, which is represented as N herein.

The vehicle 12 is positioned within the first coverage area 110 at time t₀ and not within the second coverage area 120 at time t₀. In the illustrated scenario, the first coverage area 110 changes such that the vehicle is no longer within the first coverage area 110 at time t₁, and the second coverage area 120 changes such that the vehicle is now located within the second coverage area 120 at time t₁. The vehicle 12 can use the method discussed herein to monitor cellular parameters that pertain to cellular coverage (e.g., cellular connectivity parameters) of different cellular coverage areas, such as those that are serviced by different cellular providers. For example, when the vehicle transitions from a primary propulsion on state to a primary propulsion off state, the vehicle can select a particular modem of the plurality of modems (only two shown in FIG. 1, although the telematics unit 30 can contain more in other embodiments) to remain active or powered on while the vehicle is in the primary propulsion off state. The other non-selected modem(s) can be turned off so as to conserve battery power of the vehicle. The vehicle can then periodically monitor the cellular parameters of the selected modem and reassess the current cellular coverage of the single active (or selected) modem and, when those cellular connectivity parameters fall below or exceed certain predefined threshold values, the vehicle can reassess the cellular parameters of all of the modems (or at least the other modems besides the single active modem) so as to select the modem associated with the best cellular coverage at that time. As illustrated in the scenario of FIG. 2, the cellular coverage area can change even when the vehicle remains in a fixed location.

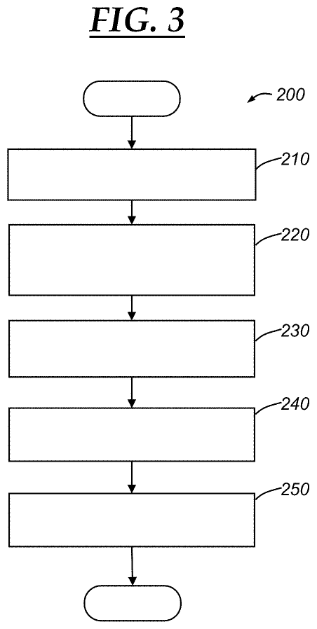

With reference to FIG. 3, there is shown an embodiment of a method 200 of selecting a modem for cellular communications while the vehicle is in a primary propulsion off state. In at least some embodiments, the method 200 is carried out by the vehicle electronics 20 and, in a particular embodiment, the method 200 is carried out by the telematics unit 30, such as through use of computer instructions stored on memory 38 and executed by the processor 36. Although the steps of the method 200 are described as being carried out in a particular order, it is hereby contemplated that the steps of the method 200 can be carried out in any suitable order as will be appreciated by those skilled in the art.

The method 200 begins with step 210, wherein a transition from a primary propulsion on state to a primary propulsion off state is detected at the vehicle. In one embodiment, the BCM 24 and/or the ECM 26 can detect that the vehicle has been placed into a primary propulsion off state. In another embodiment, an ignition control unit (not shown) can detect that the vehicle has been placed into a primary propulsion off state. These modules that detect the transition of the vehicle from the primary propulsion on state to the primary propulsion off state, can then inform the telematics unit 30, such as through sending a message via communications bus 40. Moreover, in some embodiments, detecting the presence of the primary propulsion off state may be considered as detecting a transition from a primary propulsion on state to a primary propulsion off state. The method 200 continues to step 220.

In step 220, cellular connectivity parameters are measured for each of the modems of the vehicle. As mentioned above, the telematics unit 30 includes a plurality of modems, the number of which is represented by N. The telematics unit 30 (or other portion of the vehicle electronics 20) can then measure cellular connectivity parameters for each of these N modems. A cellular connectivity parameter is a parameter that provides information as to the present strength or viability of cellular coverage for a particular modem of the UE at the current location of the UE (e.g., the telematics unit 30). A first example of a cellular connectivity parameter is a received signal strength indicator (RSSI), and a second example of a cellular connectivity parameter is the standard deviation of the RSSI as measured based on K samples. RSSI is an example of a cellular signal strength parameter. In one embodiment, any one or more of the cellular connectivity parameters can be measured K times for each of the N modems, which results in K×N number of measurements. For example, for the first modem 32, ten samples (K=10) of RSSI can be obtained and the average of these ten samples can be used as the representative parameter value (or representative RSSI value) for this first cellular connectivity parameter. Then, for these ten samples for the first modem 32, a standard deviation S can be determined, such as is follows:

$$S = \sqrt{\frac{{{Σ}_{k = 1}^{K} ( {x}_{k} - \overline{x} )}^{2}}{K}} ,$$

where K is the number of samples, xₖ is the RSSI of the k-th sample, and x̅ is the effective value for this first cellular connectivity parameter (or the average RSSI for the K samples). Other cellular connectivity parameters can be measured, such as those relating to signal strength, quality of service, etc. Once the cellular connectivity parameters are measured or otherwise obtained for each of the N modems, the method 200 continues to step 230.

In step 230, one of the plurality of modems are selected based on the cellular connectivity parameters as determined in step 220. In one embodiment, the modem with the highest RSSI (e.g., highest representative RSSI value) can be selected. In another embodiment, both the RSSI and the standard deviation of the RSSI can be taken into consideration. For example, an overall cellular connectivity value can be determined by dividing the representative RSSI value by the standard deviation (overall cellular connectivity value=x̅/S). Then, the modem with the highest or best overall cellular connectivity value can be selected. In one embodiment, the modem with the lowest anticipated electrical power consumption can be selected, and the best overall cellular connectivity value can be determined as being the overall cellular connectivity value that is associated with the lowest anticipated electrical power consumption (when compared to the anticipated electrical power consumption of each of the other modems/overall cellular connectivity values). Also, those modems that have a cellular connectivity parameter value above or below a particular cellular connectivity parameter threshold may be removed for consideration without evaluating the modem performance (such as through using x̅/S). For example, when the RSSI is below a particular RSSI threshold value, the associated modem may be removed from consideration in being selected as the selected modem, or when the standard deviation of the RSSI is above a particular threshold value, the associated modem may be removed from consideration in being selected as the selected modem. The method 200 then continues to step 240.

In step 240, the non-selected modem(s) of the plurality of modems are turned off. The non-selected modem(s) of the plurality of modems are the plurality of modems other than the selected modem (see step 230). For example, if modem m is selected in step 230, then modems 1 to m−1 and modems m+1 to N are turned off. In one embodiment, the non-selected modem(s) can be turned off by the telematics unit 30. In at least one embodiment, the selected modem operates such that cellular communications are receivable by the selected modem. At least in some scenarios, the vehicle is in a primary propulsion off state and, thus, conservation of battery power is desired. In one embodiment, the selected modem can operate in a low power mode such that cellular messages are still receivable by the selected modem. The method 200 then continues to step 250.

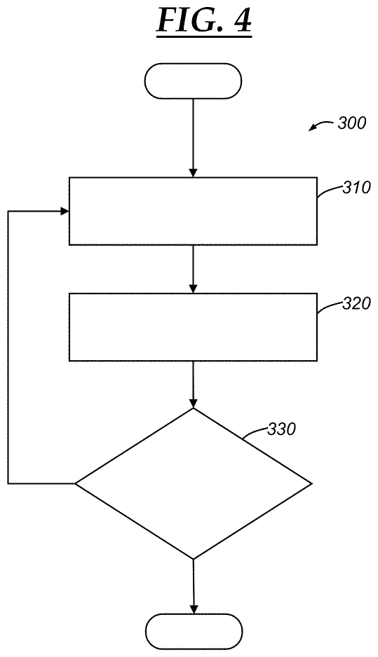

In step 250, the vehicle sends a selected modem indication to a remote server. The selected modem indication includes data or information that indicates which modem the vehicle selected to use for cellular communications while in the primary propulsion off state. In one embodiment, this selected modem indication is sent by the telematics unit 30 using the selected modem, which can be, for example, the first modem 32. In some scenarios, informing the remote server of the selected modem can help facilitate communications between the vehicle and the remote server since the remote server can direct communications to the selected modem. The selected modem indication can include an IMSI or an IMEI of the selected modem, or any other information that uniquely identifies the selected modem from the non-selected modem(s). In an alternative embodiment, step 250 may be omitted and, in some such circumstances, the remote server can send a message to each of the plurality of modems or until a response is received from the vehicle. The method 200 then ends; however, in at least some embodiments, the method 300 (FIG. 4) can be carried out to monitor the cellular coverage of the selected modem and/or to determine whether to select another modem of the plurality of modems as being the modem that is to carry out communications, as will be discussed below.

With reference to FIG. 4, there is shown an embodiment of a method 300 for monitoring cellular connectivity parameters for a selected modem. In at least some embodiments, the method 300 is carried out by the vehicle electronics 20 and, in a particular embodiment, the method 300 is carried out by the telematics unit 30, such as through use of computer instructions stored on memory 38 and executed by processor 36. Although the steps of the method 300 are described as being carried out in a particular order, it is hereby contemplated that the steps of the method 300 can be carried out in any suitable order as will be appreciated by those skilled in the art.

As mentioned above, according to some embodiments, the method 300 can be carried out after the method 200—for example, the method 300 can be carried out after step 250 in which the selected modem indication is sent from the vehicle to the remote server. The method 300 begins with step 310, wherein the vehicle waits a predetermined amount of time. This predetermined amount of time sets an interval in which the other steps of the method 300 are carried out, and this interval can be referred to as a cellular parameter monitoring interval. The predetermined amount of time (or cellular parameter monitoring interval) is set to a static amount of time, such as 30 minutes. In other embodiments, the cellular parameter monitoring interval can be dynamically adjusted based on certain information relating to the operation of the vehicle or the cellular network(s), such as the cellular connectivity parameter values as obtained in the method 200 or in step 320. Once the predetermined amount of time expires, then the method 300 continues to step 320.

In step 320, the cellular connectivity parameters for the selected modem are measured. This step is similar to step 220 of the method 200, except that (at least in some embodiments) the cellular parameter monitoring interval are only measured for the selected modem and not for the plurality of modems. In other embodiments, cellular connectivity parameters that are different from those measured in step 220 (method 200 of FIG. 3) can be measured. The method 300 then continues to step 330.

In step 330, it is determined whether a new modem should be (or is to be) selected. In at least some embodiments, this determination is made based on the cellular connectivity parameter values for the selected modem that were obtained in step 320. In one embodiment, it can be determined whether the cellular connectivity parameter values fall below or exceed certain predefined threshold values. For example, when the RSSI (as measured/determined in step 320) is below a particular RSSI threshold value, it can be determined to select a new modem, or when the standard deviation of the RSSI (as measured/determined in step 320) is above a particular threshold value, it can be determined to select a new modem. When it is determined not to select a new modem, the method 300 then continues back to step 310, where the method waits a predetermined amount of time before re-measuring the cellular connectivity parameters for the selected modem. Otherwise, the method 300 continues back to step 220 of the method 200.

In the case that the method continues back to step 220, the steps 220 through 250 can be carried out to select a new modem. In one embodiment, the step 220 can be carried out for all of the modems other than the previously-selected modem (the modem in which the cellular connectivity parameters were measured for in step 320). Also, in some embodiments of this iteration of step 230, the previously-selected modem can be removed from being considered as a modem for selection. Also, after this iteration of the method 200, the method 300 can be carried out again to monitor the cellular connectivity of the newly-selected modem.

In at least one embodiment, the method can further include the step of receiving a remote vehicle command from a remote server, such as the remote server 78. The remote vehicle command is received via the selected (or active) modem at the telematics unit 30 while the vehicle is in the primary propulsion off state. The remote vehicle command can be a command to control the vehicle, such as a command to unlock the vehicle doors or start the vehicle ignition (or otherwise cause a transition from a primary propulsion off state to a primary propulsion on state). The remote vehicle command can include a door lock or unlock command, a primary propulsion start command (e.g., an engine start command), a localization command or request, an activate horn and/or blinker command, a disable vehicle start command, or a decrease vehicle speed command. Of course, numerous other remote vehicle commands not explicitly described herein can be sent to the vehicle from the remote server.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A method of selecting a modem for cellular communications while the vehicle is in a primary propulsion off state, the method comprising:
detecting a transition from a primary propulsion on state to a primary propulsion off state of the vehicle;
after detecting the transition from the primary propulsion on state to the primary propulsion off state, measuring one or more cellular connectivity parameters for a plurality of modems included in the vehicle;
based on the cellular connectivity parameter(s), selecting a modem of the plurality of modems;
after selecting the modem of the plurality of modems, then turning off non-selected modem(s) of the plurality of modems, wherein the non-selected modem(s) include the plurality of modems other than the selected modem; and
sending a selected modem indication to a remote server, wherein the selected modem indication indicates to the remote server to use the selected modem when sending messages to the vehicle.

2. The method of claim 1, wherein the cellular connectivity parameter(s) include(s) a cellular signal strength parameter.

3. The method of claim 2, wherein the cellular signal strength parameter is a received signal strength indicator (RSSI).

4. The method of claim 3, wherein the measuring step includes measuring K samples of the RSSI for each of the plurality of modems and then determining a representative RSSI value.

5. The method of claim 4, wherein the cellular connectivity parameter(s) include(s) a standard deviation of the RSSI as measured based on the K samples.

6. The method of claim 5, wherein an overall cellular connectivity value is determined for two or more of the plurality of modems by dividing the representative RSSI value by the standard deviation of the RSSI and, then, carrying out the selecting step based on the overall cellular connectivity values.

7. The method of claim 6, wherein the selecting step includes comparing the representative RSSI values for each of the plurality of modems to a first cellular connectivity parameter threshold and, when it is determined that the representative RSSI values for an associated modem is above the first cellular connectivity parameter threshold, then determining the overall cellular connectivity value for the associated modem.

8. The method of claim 7, wherein the selecting step includes comparing the standard deviation of the RSSI for each of the plurality of modems to a second cellular connectivity parameter threshold and, when it is determined that both the representative RSSI values for the associated modem is above the first cellular connectivity parameter threshold and the standard deviation of the RSSI for the associated modem is below the second cellular connectivity parameter threshold, then determining the overall cellular connectivity value for the associated modem.

9. The method of claim 1, wherein the method further comprises the steps of:
monitoring at least one cellular connectivity parameter for the selected modem while the vehicle is in the primary propulsion off state by measuring the cellular connectivity parameters for the selected modem; and
based on the at least one cellular connectivity parameter, determining whether to select a new modem for cellular communications while the vehicle is in the primary propulsion off state.

10. The method of claim 9, wherein the determining step includes comparing a first cellular connectivity parameter of the at least one cellular connectivity parameter to a first cellular connectivity parameter threshold.

11. The method of claim 10, wherein, when it is determined to select a new modem for cellular communications while the vehicle is in the primary propulsion off state, then carrying out the measuring step for the non-selected modem(s) and the selecting step to select a modem of the non-selected modem(s) to be the selected modem.

12. A method for cellular communications while the vehicle is in a primary propulsion off state, the method comprising:
detecting a transition from a primary propulsion on state to a primary propulsion off state of the vehicle;
after detecting the transition from the primary propulsion on state to the primary propulsion off state, measuring a plurality of cellular connectivity parameters for a plurality of cellular modems included in the vehicle, wherein the cellular connectivity parameters include a cellular signal strength parameter and a standard deviation of the cellular signal strength parameter as taken over K samples of the cellular signal strength parameter;
based on the cellular connectivity parameters, selecting a modem of the plurality of modems by:
comparing the cellular signal strength parameter to a first cellular connectivity parameter threshold;
comparing the standard deviation of the cellular signal strength parameter to a second cellular connectivity parameter threshold;
for each of the plurality of modems in which both the cellular signal strength parameter is above the first cellular connectivity parameter threshold and the standard deviation of the cellular signal strength parameter is below a second cellular connectivity parameter threshold, determining an overall cellular connectivity value based on the cellular signal strength parameter and the standard deviation of the cellular signal strength parameter; and
selecting the modem with the best overall cellular connectivity value;
after selecting the modem of the plurality of modems, then turning off non-selected modem(s) of the plurality of modems, wherein the non-selected modem(s) include the plurality of modems other than the selected modem; and
sending a selected modem indication to a remote server, wherein the selected modem indication informs the remote server of a cellular provider that is associated with the selected modem and that is to be used for communications between the vehicle and the remote server.

13. The method of claim 12, wherein a first modem of the plurality of modems is configured to provide cellular services for the vehicle using a first cellular provider, wherein a second modem of the plurality of modems is configured to provide cellular services for the vehicle using a second cellular provider, and wherein the first cellular provider is different than the second cellular provider.

14. The method of claim 12, wherein the method further comprises the steps of:
monitoring at least one cellular connectivity parameter for the selected modem while the vehicle is in the primary propulsion off state; and
based on the at least one cellular connectivity parameter, determining whether to select a new modem for cellular communications while the vehicle is in the primary propulsion off state.

15. The method of claim 14, wherein, when it is determined to select a new modem for cellular communications while the vehicle is in the primary propulsion off state, then carrying out the measuring step for the non-selected modem(s) and the selecting step to select a modem of the non-selected modem(s) to be the selected modem.

16. The method of claim 12, wherein the best overall cellular connectivity value is determined to be associated with the lowest anticipated amount of electrical power consumption.

17. The method of claim 12, further comprising the step of receiving a remote vehicle command at the selected modem from the remote server while the vehicle is in the primary propulsion off state.

18. The method of claim 12, wherein the method is carried out by a telematics unit included in the vehicle, and wherein the telematics unit includes the plurality of modems.

19. The method of claim 18, wherein the method further comprises turning on each of the plurality of modems in response to detecting a transition from the primary propulsion off state to the primary propulsion on state.

20. The method of claim 19, wherein the vehicle informs the remote server of vehicle operation in response to detecting the transition from the primary propulsion off state to the primary propulsion on state so that the remote server is informed of which modems of the plurality of modems are turned on.
